(19) United States
(12) Patent Application Publication
(10) Pub. No.: US 2022/0301487 A1
(43) Pub. Date: Sep. 22, 2022

(54) PIXEL CIRCUIT AND DRIVING METHOD

(71) Applicant: WUHAN CHINA STAR OPTOELECTRONICS SEMICONDUCTOR DISPLAY TECHNOLOGY CO., LTD., Wuhan (CN)

(72) Inventors: Xuanyun Wang, Wuhan (CN); Sunghwan Cho, Wuhan (CN); Chao Dai, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 17/264,288

(22) PCT Filed: Aug. 20, 2020
(86) PCT No.: PCT/CN2020/110137

§ 371 Date: Jan. 28, 2021

(30) Foreign Application Priority Data
Jul. 16, 2020 (CN) 202010684989.8

(51) Int. Cl. G09G 3/32

(52) U.S. Cl. CPC G09G 3/32; G09G 2310/0297; G09G 2310/061; G09G 2300/0842

(57) ABSTRACT

The present application provides a pixel circuit and a driving method. Writing of a data signal to each sub-pixel circuit is independently controlled by a respectively corresponding demultiplexing signal, which is beneficial to realize an ultra-high frequency driven display. The first sub-pixel circuit and the second sub-pixel circuit share the same data signal, so that less data lines are required. The driving transistor is a polysilicon thin-film transistor, and the compensation transistor is an oxide thin-film transistor, so a current leakage of the driving transistor is reduced or eliminated.

### FIELD OF DISCLOSURE

The present application relates to a field of display technology, in particular to a field of pixel technology, and specifically to a pixel circuit and a driving method.

### DESCRIPTION OF RELATED ART

With the development of multimedia, display devices have become more and more important. Accordingly, the requirements for various types of display devices are getting higher and higher, especially in the field of smartphones. In the present and future, at least one or a combination of an ultra-high frequency driven display, a low-power driven display, and a low frequency driven display is the development direction of the display devices.

In conventional pixel circuits, a data signal is usually written into a pixel circuit correspondingly, so that more data lines are required to transmit data signals, thus occupying a large layout space in the display panel; and the writing of the data signals is limited by the control of the scan signal, thus hindering the development of the pixel circuits toward ultra-high frequency driven displays.

### SUMMARY

The present application provides a pixel circuit and a driving method, which solves a problem that it is difficult to use a conventional pixel circuit to realize ultra-high frequency driven displays.

In a first aspect, the present application provides a pixel circuit, comprising:

a first sub-pixel circuit;

a second sub-pixel circuit; and

a writing circuit connected to the first sub-pixel circuit and the second sub-pixel circuit, wherein the writing circuit is configured to control a data signal to be coupled to the first sub-pixel circuit based on a first demultiplexing signal, and control the data signal to be coupled to the second sub-pixel circuit according to a second demultiplexing signal.

According to a first embodiment based on the first aspect, an input signal of the first sub-pixel circuit is the same as an input signal of the second sub-pixel circuit;

wherein the input signal comprises at least one of a first power signal, a second power signal, a light-emitting control signal, a scan signal, and an initial voltage signal.

According to a second embodiment based on the first aspect, the writing circuit comprises:

a first thin-film transistor coupled to the first sub-pixel circuit and configured to control the data signal to be coupled to the first sub-pixel circuit according to the first demultiplexing signal; and

a second thin-film transistor coupled to the second sub-pixel circuit and configured to control the data signal to be coupled to the second sub-pixel circuit according to the second demultiplexing signal;

wherein the first demultiplexing signal is different from the second demultiplexing signal.

According to a third embodiment based on the first aspect, the first sub-pixel circuit or the second sub-pixel circuit comprises:

a driving unit connected in series to a light-emitting circuit consisting of a first power signal and a second power signal and configured to control a current flowing through the light-emitting circuit; and

a compensation unit coupled to the driving unit and configured to adjust a potential of a control terminal of the driving unit to a potential of an output terminal of the driving unit according to a second scan signal, so as to reduce or eliminate a current leakage of the driving unit.

According to a fourth embodiment based on the third embodiment of the first aspect, the first sub-pixel circuit or the second sub-pixel circuit further comprises:

an initialization unit connected to the driving unit and configured to control an initial voltage signal to be coupled to the driving unit according to the first scan signal.

According to a fifth embodiment based on the fourth embodiment of the first aspect, the first sub-pixel circuit or the second sub-pixel circuit further comprises:

a storage unit coupled to the driving unit, the initialization unit, and the first power signal, wherein the storage unit is configured to adjust the potential of the control terminal of the driving unit.

According to a sixth embodiment based on the fifth embodiment of the first aspect, the first sub-pixel circuit or the second sub-pixel circuit further comprises:

a light-emitting unit connected in series to the light-emitting circuit; and

a light-emitting control unit connected in series to the light-emitting circuit and configured to on-off control the light-emitting unit to emit light according to a light-emitting control signal.

According to a seventh embodiment based on the sixth embodiment of the first aspect, wherein the first sub-pixel circuit or the second sub-pixel circuit further comprises:

a reset unit connected to the initial voltage signal and an anode of the light-emitting unit and configured to control the initial voltage signal to be coupled to the anode of the light-emitting unit according to a third scan signal to reset a potential of the anode.

In a second aspect, the present application provides a pixel circuit, comprising:

a first sub-pixel circuit; and

a writing circuit connected to the first sub-pixel circuit and configured to control a data signal to be coupled to the first sub-pixel circuit according to a first demultiplexing signal.

According to a first embodiment based on the second aspect, the first sub-pixel circuit comprises:

a driving transistor, wherein a source of the driving transistor is connected to an output terminal of the writing circuit; and

a compensation transistor, wherein an input terminal of the compensation transistor is connected to a gate of the driving transistor, an output terminal of the compensation transistor is connected to a drain of the driving transistor, and a control terminal of the compensation transistor is connected to a second scan signal and configured to adjust a potential difference between the gate and the drain of the driving transistor according to the second scan signal to reduce or eliminate a current leakage of the driving transistor.

According to a second embodiment based on the first embodiment of the second aspect, the driving transistor is a polysilicon thin-film transistor, and the compensation transistor is an oxide thin-film transistor.

According to a third embodiment based on the second embodiment of the second aspect, the first sub-pixel circuit further comprises an initialization transistor;

an input terminal of the initialization transistor is connected to an initial voltage signal, a control terminal of the initialization transistor is connected to a first scan signal, and an output terminal of the initialization transistor is connected to the gate of the driving transistor.

According to a fourth embodiment based on the third embodiment of the second aspect, the first sub-pixel circuit further comprises a storage capacitor;

a first end of the storage capacitor is connected to a first power signal, and a second end of the storage capacitor is connected to the gate of the driving transistor.

According to a fifth embodiment based on the fourth embodiment of the second aspect, the first sub-pixel circuit further comprises a first light-emitting control transistor, a second light-emitting control transistor, and a light-emitting device;

an input terminal of the first light-emitting control transistor is connected to the first power signal, and an output terminal of the first light-emitting control transistor is connected to the source of the driving transistor;

an input terminal of the second light-emitting control transistor is connected to the drain of the driving transistor, and the light-emitting control signal is connected to a control terminal of the first light-emitting control transistor and a control terminal of the second light-emitting control transistor; and

an anode of the light-emitting device is connected to an output terminal of the second light-emitting control transistor, and a cathode of the light-emitting device is connected to a second power signal.

According to a sixth embodiment based on the fifth embodiment of the second aspect, the first sub-pixel circuit further comprises a reset transistor;

an input terminal of the reset transistor is connected to the initial voltage signal; a control terminal of the reset transistor is connected to a third scan signal; and an output terminal of the reset transistor is connected to the output terminal of the second light-emitting control transistor.

According to a seventh embodiment based on the third embodiment of the second aspect, the initialization transistor is an oxide thin-film transistor.

In a third aspect, the present application provides a driving method of a pixel circuit, wherein the pixel circuit is provided with a first sub-pixel circuit, a second sub-pixel circuit, and a writing circuit, and the driving method comprises:

providing a first demultiplexing signal, a second demultiplexing signal, a data signal, and a corresponding input signal, wherein the input signal comprises at least one of a first power signal, a second power signal, a light-emitting control signal, a first scan signal, a second scan signal, a third scan signal, and an initial voltage signal;

the writing circuit controlling the data signal to be coupled to the first sub-pixel circuit according to the first demultiplexing signal;

the writing circuit controlling the data signal to be coupled to the second sub-pixel circuit according to the second demultiplexing signal;

the first sub-pixel circuit driving a first light-emitting unit according to the input signal to perform a first display operation; and

the second sub-pixel circuit driving a second light-emitting unit according to the input signal to perform a second display operation;

wherein a frequency of the third scan signal is less than or equal to a sum of frequencies of the first demultiplexing signal and the second demultiplexing signal.

According to a first embodiment based on the third aspect, demultiplexing signals comprise the first demultiplexing signal and the second demultiplexing signal; the writing circuit comprises a first writing circuit and a second writing circuit;

the first writing circuit controls the data signal to be coupled to the first sub-pixel circuit according to the first demultiplexing signal; and

the second writing circuit controls the data signal to be coupled to the second sub-pixel circuit according to the second demultiplexing signal.

According to a second embodiment based on the first embodiment of the third aspect, a frequency of the first demultiplexing signal is the same as a frequency of the second demultiplexing signal.

In a fourth aspect, the present application provides a display panel. The display panel comprises the pixel circuit of any one of the above embodiments and a demultiplexing circuit; and the demultiplexing circuit is connected to the pixel circuit and configured to provide the corresponding demultiplexing signal to the pixel circuit.

The pixel circuit and the driving method of the present application enables the writing of the data signal to each sub-pixel circuit to be independently controlled by the respectively corresponding demultiplexing signal, thus avoiding being restricted by the control of the scan signal, and facilitating the realization of an ultra-high frequency driven display. The first sub-pixel circuit and the second sub-pixel circuit share the same data signal, which can reduce the number of data lines used, thereby reducing a space occupied by the data lines. The driving transistor is a polysilicon thin-film transistor, and the compensation transistor is an oxide thin-film transistor, which can reduce or eliminate a current leakage of the driving transistor.

### BRIEF DESCRIPTION OF DRAWINGS

In order to more clearly illustrate the embodiments of the present disclosure or related art, figures which will be described in the embodiments are briefly introduced hereinafter. It is obvious that the drawings are merely for the purposes of illustrating some embodiments of the present disclosure, and a person having ordinary skill in this field can obtain other figures according to these figures without inventive work.

FIG. 1 is a schematic diagram illustrating a pixel circuit according to one embodiment of the present application.

FIG. 2 is a circuit diagram illustrating the pixel circuit according to one embodiment of the present application.

FIG. 3 is another circuit diagram illustrating the pixel circuit according to one embodiment of the present application.

FIG. 4 is a process flow diagram illustrating a driving method according to one embodiment of the present application.

FIG. 5 is a timing diagram illustrating the pixel circuit shown in FIG. 2.

### DETAILED DESCRIPTION OF EMBODIMENTS

In order to make the purpose, technical solutions and effects of the present application clearer, the following description is provided with reference to the accompanying drawings and in conjunction with specific embodiments. It should be understood that the specific embodiments described herein are only used to explain the present application, and not used to limit the present application.

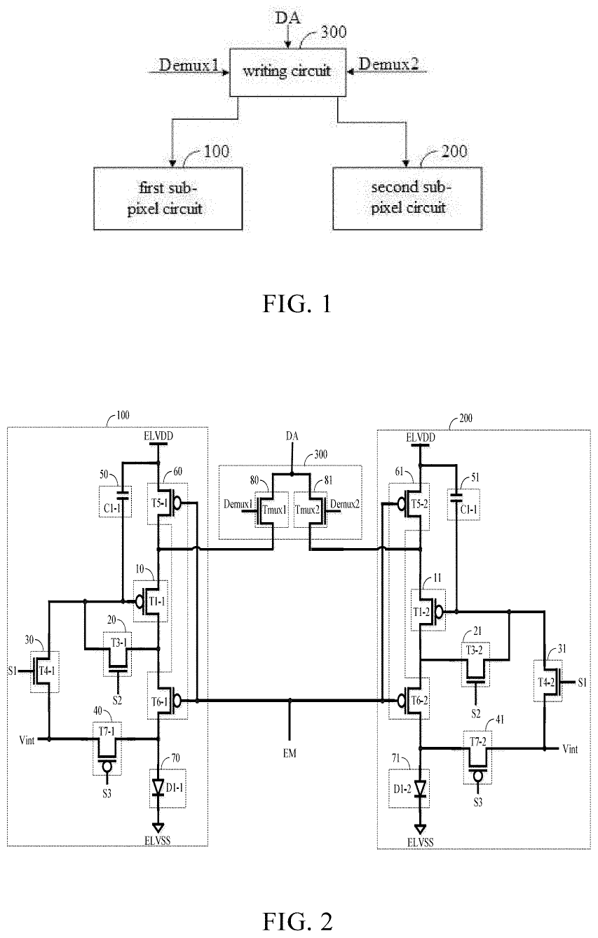

As shown in FIG. 1, the present embodiment provides a pixel circuit, comprising: a first sub-pixel circuit 100; a second sub-pixel circuit 200; and a writing circuit 300. The writing circuit 300 is connected to the first sub-pixel circuit 100 and the second sub-pixel circuit 200 and configured to control a data signal DA to be coupled to the first sub-pixel circuit 100 according to a first demultiplexing signal Demux1, and control the data signal DA to be coupled to the second sub-pixel circuit 200 according to a second demultiplexing signal Demux2.

It should be noted that the first sub-pixel circuit 100 adopts, but is not limited to, a same circuit structure as the second sub-pixel circuit 200. The pixel circuit of the present embodiment enables writing of the data signal DA to each sub-pixel circuit to be indecently controlled by the respectively corresponding demultiplexing signal, which avoids being restricted by the control of a scan signal and is beneficial to realize an ultra-high frequency driven display. The first sub-pixel circuit 100 and the second sub-pixel circuit 200 share the same data signal DA, thereby reducing the number of data lines used and also reducing a space occupied by the data lines.

Writing the data signal DA in a conventional pixel circuit is limited by the control of the scan signal. The scan signal needs to be generated after at least a series of modulations by a timing controller, a GOA circuit, or a gate driver, and a change in frequencies of the scan signal is restricted in many aspects. Therefore, when the scan signal is used to control the writing of the data signal DA, the development of the pixel circuit toward the ultra-high frequency driven display is hindered. To solve this problem, the present invention uses the mutually independent demultiplexing signals to control the writing of the data signal DA. The corresponding demultiplexing signal is a square wave signal whose frequency can be obtained without complicated modulations, thus reducing the difficulty in design, overcoming a technical prejudice in this industry by making the writing of the data signal DA more efficient and freer, and creating a new idea for the realization of the ultra-high frequency driven display.

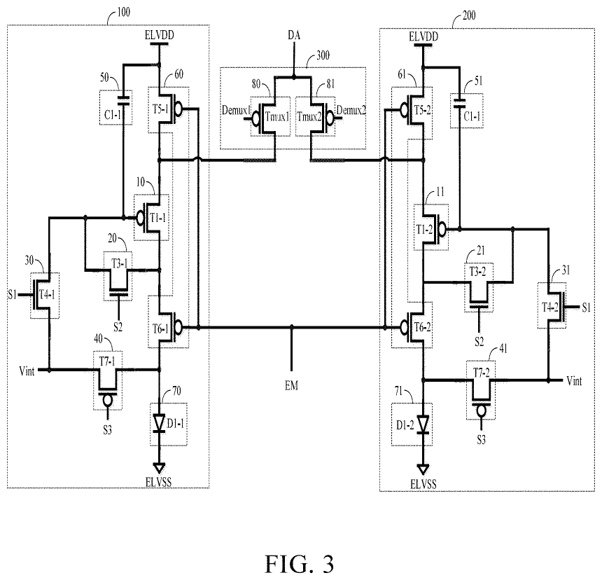

As shown in FIG. 2 or FIG. 3, in one embodiment, an input signal of the first sub-pixel circuit 100 is the same as an input signal of the second sub-pixel circuit 200. The input signal includes, but is not limited to, a first power signal ELVDD, a second power signal ELVSS, a light-emitting control signal EM, a scan signal, and an initial voltage signal Vint. A potential of the first power signal ELVDD is greater than a potential of the second power signal ELVSS. The scan signal includes a first scan signal S1, a second scan signal S2, and a third scan signal S3. When the first sub-pixel circuit 100 and the second sub-pixel circuit 200 are located in an Nth row of sub-pixels, the first scan signal S1 can be, but is not limited to, an (N−1)th level scan signal, the second scan signal S2 can be, but is not limited to, an Nth level scan signal, and the third scan signal S3 can be, but is not limited to, another Nth level scan signal. N can be an integer not less than 1. When N is equal to 1, the (N−1)th level scan signal is replaced by an initial signal. Accordingly, in the pixel circuit provided in the present embodiment, the first sub-pixel circuit 100 and the second sub-pixel circuit 200 can share multiple input signals, which can reduce the number of the signal lines used to transmit these input signals, and can also reduce a space occupied by the signal lines.

In one embodiment, the writing circuit 300 comprises a first thin-film transistor Tmux1; an input terminal of the first thin-film transistor Tmux1 is connected to the data signal DA; a control terminal of the first thin-film transistor Tmux1 is connected to the corresponding demultiplexing signal; and an output terminal of the first thin-film transistor Tmux1 is coupled to the first sub-pixel circuit 100 and the second sub-pixel circuit 200.

It should be noted that an input terminal of a transistor in the present disclosure can be, but is not limited to, a source of the corresponding transistor, and can also be a drain of the corresponding transistor; an output terminal of a transistor can be, but is not limited to, a source of the corresponding transistor, and can also be a drain of the corresponding transistor; and a control terminal of a transistor is a gate of the corresponding transistor.

In one embodiment, the writing circuit 300 comprises the first thin-film transistor Tmux1 and a second thin-film transistor Tmux2; the first thin-film transistor Tmux1 is coupled to the first sub-pixel circuit 100 and configured to control the data signal DA to be coupled to the first sub-pixel circuit 100 according to the corresponding demultiplexing signal; the second thin-film transistor Tmux2 is coupled to the second sub-pixel circuit 200 and configured to control the data signal DA to be coupled to the second sub-pixel circuit 200 according to the corresponding demultiplexing signal.

In one embodiment, the writing circuit 300 comprises the first thin-film transistor Tmux1 and the second thin-film transistor Tmux2. The first thin-film transistor Tmux1 is coupled to the first sub-pixel circuit 100 and configured to control the data signal DA to be coupled to the first sub-pixel circuit 100 according to the first demultiplexing signal Demux1; and the second thin-film transistor Tmux2 is coupled to the second sub-pixel circuit 200 and configured to control the data signal DA to be coupled to the second sub-pixel circuit 200 according to the second demultiplexing signal Demux2. The first demultiplexing signal Demux1 is different from the second demultiplexing signal Demux2.

It should be noted that, as shown in FIG. 2, the first thin-film transistor Tmux1 and the second thin-film transistor Tmux2 are both an N-channel thin-film transistor. As shown in FIG. 3, the first thin-film transistor Tmux1 and the second thin-film transistor Tmux2 are both a P-channel thin-film transistor.

It can be understood that, in one embodiment, the first thin-film transistor Tmux1 can be an N-channel thin-film transistor, and the second thin-film transistor Tmux2 can be a P-channel thin-film transistor. Alternatively, the first thin-film transistor Tmux1 can be a P-channel thin-film transistor, and the second thin-film transistor Tmux2 can be an N-channel thin-film transistor.

In one embodiment, the first sub-pixel circuit 100 or the second sub-pixel circuit 200 comprises a light-emitting unit 70, a driving unit 10, a light-emitting control unit 60, and an initialization unit 30. The light-emitting unit 70 is connected in series to the first power signal ELVDD and the second power signal ELVSS to constitute a light-emitting circuit. The driving unit 10 is connected in series to the light-emitting circuit to control a current flowing through the light-emitting circuit. The light-emitting control unit 60 is connected in series to the light-emitting circuit and is configured to on-off control the light-emitting unit 70 to emit light according to the light-emitting control signal EM. The initialization unit 30 is connected to the driving unit 10 for controlling the initial voltage signal Vint to be coupled to the driving unit 10 according to the first scan signal S1.

The driving unit 10 can include a driving transistor T1-1. The driving transistor T1-1 can be, but is not limited to, a polysilicon thin-film transistor or a low temperature polysilicon thin-film transistor, and can also be an oxide thin-film transistor or a metal oxide thin-film transistor. Further, the driving transistor T1-1 can be a P-channel thin-film transistor.

The light-emitting control unit 60 can include a first light-emitting control transistor T5-1 and a second light-emitting control transistor T6-1; an input terminal of the first light-emitting control transistor T5-1 is connected to the first power signal ELVDD; an output terminal of the first light-emitting control transistor T5-1 is connected to a source of the driving transistor T1-1; an input terminal of the second light-emitting control transistor T6-1 is connected to a drain of the driving transistor T1-1; the light-emitting control signal EM is connected to a control terminal of the first light-emitting control transistor T5-1 and a control terminal of the second light-emitting control transistor T6-1. The first light-emitting control transistor T5-1 and the second light-emitting control transistor T6-1 can be P-channel thin-film transistors and/or low temperature polysilicon thin-film transistors.

The light-emitting unit 70 can include a light-emitting device D1-1; an anode of the light-emitting device D1-1 is connected to an output terminal of the second light-emitting control transistor T6-1; and a cathode of the light-emitting device D1-1 is connected to the second power signal ELVSS.

It should be noted that the light-emitting device D1-1 can be, but is not limited to, a self-luminous light-emitting device such as an organic light-emitting diode (OLED) light-emitting device, and the light-emitting device D1-1 can also be a mini-LED or micro-LED light-emitting device.

The initialization unit 30 can include an initialization transistor T4-1; an input terminal of the initialization transistor T4-1 is connected to the initial voltage signal Vint; a control terminal of the initialization transistor T4-1 is connected to the first scan signal S1; and an output terminal of the initialization transistor T4-1 is connected to a gate of the driving transistor T1-1. The initialization transistor T4-1 can be, but is not limited to, an oxide thin-film transistor or a metal oxide thin-film transistor, and the initialization transistor T4-1 can also be a polysilicon thin-film transistor or a low temperature polysilicon thin-film transistor, wherein the initialization transistor T4-1 can be an N-channel thin-film transistor.

In one embodiment, the first sub-pixel circuit 100 or the second sub-pixel circuit 200 further comprises a storage unit 50. The storage unit 50 is coupled to the driving unit 10, the initialization unit 30, and the first power signal ELVDD for adjusting a potential of a control terminal of the driving unit 10.

The storage unit 50 can comprise a storage capacitor C1-1; a first end of the storage capacitor C1-1 is connected to the first power signal ELVDD; a second end of the storage capacitor C1-1 is connected to the gate of the driving transistor T1-1.

In one embodiment, the first sub-pixel circuit 100 or the second sub-pixel circuit 200 further comprises a compensation unit 20; the compensation unit 20 is coupled to the driving unit 10 for adjusting the potential of the control terminal of the driving unit 10 to a potential of an output terminal of the driving unit 10 according to the second scan signal S2, so as to reduce or eliminate a current leakage of the driving unit 10.

The compensation unit 20 can comprise a compensation transistor T3-1. The compensation transistor T3-1 can be, but is not limited to, an oxide thin-film transistor or a metal oxide thin-film transistor, and the compensation transistor T3-1 can also be a polysilicon thin-film transistor or a low temperature polysilicon thin-film transistor. The compensation transistor T3-1 can also be an N-channel thin-film transistor.

In one embodiment, the first sub-pixel circuit 100 or the second sub-pixel circuit 200 further comprises a reset unit 40; the reset unit 40 is connected to the initial voltage signal Vint and an anode of the light-emitting unit 70, and is configured to control the initial voltage signal Vint to be coupled to the anode of the light-emitting unit 70 according to the third scan signal S3 to reset a potential of the anode of the light-emitting unit 70.

The reset unit 40 can comprise a reset transistor T7-1; an input terminal of the reset transistor T7-1 is connected to the initial voltage signal Vint; a control terminal of the reset transistor T7-1 is connected to the third scan signal S3; an output terminal of the reset transistor T7-1 is connected to the output terminal of the second light-emitting control transistor T6-1. The reset transistor T7-1 can be, but is not limited to, a low-temperature polysilicon thin-film transistor, and can also be a P-channel thin-film transistor.

In one embodiment, the pixel circuit comprises the first sub-pixel circuit 100 and the writing circuit 300. The writing circuit 300 is connected to the first sub-pixel circuit 100 for controlling the data signal DA to be coupled to the first sub-pixel circuit 100 according to the corresponding demultiplexing signal. The first sub-pixel circuit 100 comprises the driving transistor T1-1 and the compensation transistor T3-1. The source of the driving transistor T1-1 is connected to an output terminal of the writing circuit 300. An input terminal of the compensation transistor T3-1 is connected to the gate of the driving transistor T1-1, an output terminal of the compensation transistor T3-1 is connected to the drain of the driving transistor T1-1, and a control terminal of the compensation transistor T3-1 is connected to the second scan signal S2 and configured to adjust a potential difference between the gate and the drain of the driving transistor T1-1 according to the second scan signal S2 to reduce or eliminate a current leakage of the driving transistor T1-1.

The compensation transistor T3-1 is connected in series between the gate and the drain of the driving transistor T1-1. In a threshold compensation stage, the compensation transistor T3-1 is turned on to compensate a threshold voltage of the driving transistor T1-1 after the data signal DA is written into the same. In a light-emission stage, the compensation transistor T3-1 is turned off. Since the compensation transistor T3-1 is connected in series between the gate and the drain of the driving transistor T1-1, a potential of the gate of the driving transistor T1-1 can be adjusted to reduce or eliminate the current leakage of the driving transistor T1-1.

When the compensation transistor T3-1 is an oxide thin-film transistor or a metal oxide thin-film transistor, its hysteresis makes the current leakage of the driving transistor T1-1 further reduced or eliminated.

The pixel circuit of the present embodiment enables the writing of the data signal DA to each sub-pixel circuit to be independently controlled by the respectively corresponding demultiplexing signal, which avoids being restricted by the control of the scan signal and is beneficial to realize an ultra-high frequency driven display. The driving transistor T1-1 is a polysilicon thin-film transistor and the compensation transistor T3-1 is an oxide thin-film transistor, thereby further reducing or eliminating the current leakage of the driving transistor T1-1.

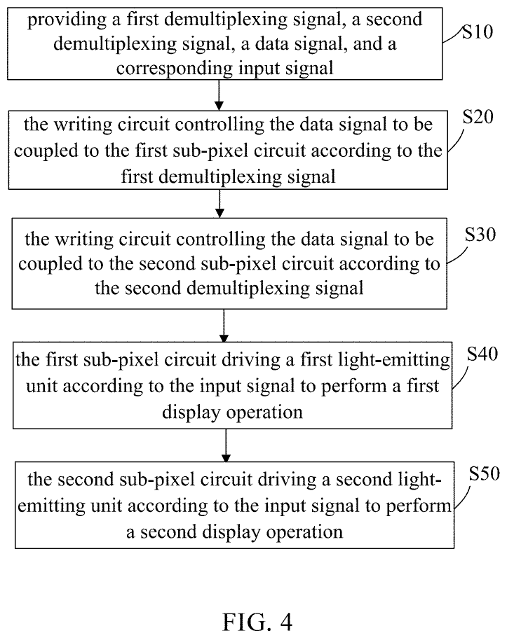

In one embodiment, the present disclosure provides a driving method of a pixel circuit, wherein the pixel circuit comprises a first sub-pixel circuit 100, a second sub-pixel circuit 200, and a writing circuit 300. The driving method shown in FIG. 4 comprises:

step S10: providing a first demultiplexing signal Demux1, a second demultiplexing signal Demux2, a data signal DA, and a corresponding input signal, wherein the input signal comprises at least one of a first power signal ELVDD, a second power signal ELVSS, a light-emitting control signal EM, a first scan signal S1, a second scan signal S2, a third scan signal S3, and an initial voltage signal Vint;

step S20: the writing circuit 300 controlling the data signal DA to be coupled to the first sub-pixel circuit 100 according to the first demultiplexing signal Demux1;

step S30: the writing circuit controlling the data signal DA to be coupled to the second sub-pixel circuit 200 according to the second demultiplexing signal Demux2;

step S40: the first sub-pixel circuit 100 driving the first light-emitting unit according to the input signal to perform a first display operation; and

step S50: the second sub-pixel circuit 200 driving the second light-emitting unit 71 according to the input signal to perform a second display operation;

wherein a frequency of the third scan signal S3 less than or equal to a sum of frequencies of the first demultiplexing signal Demux1 and the second demultiplexing signal Demux2.

The first light-emitting unit can be a light-emitting unit 70.

In one embodiment, the demultiplexing signals can comprise the first demultiplexing signal Demux1 and the second demultiplexing signal Demux2. The writing circuit 300 comprises a first writing circuit 80 and a second writing circuit 81. The writing circuit 80 controls the data signal DA to be coupled to the first sub-pixel circuit 100 according to the first demultiplexing signal Demux1. The second writing circuit 81 controls the data signal DA to be coupled to the second sub-pixel circuit 200 according to the second demultiplexing signal Demux2.

The first writing circuit 80 can comprise a first thin-film transistor Tmux1, and the second writing circuit 81 can include a second thin-film transistor Tmux2.

In one embodiment, the frequency of the first demultiplexing signal Demux1 is the same as the frequency of the second demultiplexing signal Demux2; a phase of the first demultiplexing signal Demux1 is the same or different from a phase of the second demultiplexing signal Demux2.

The frequency of the first demultiplexing signal Demux1 or the frequency of the second demultiplexing signal Demux2 is higher than the frequency of the first scan signal S1. The frequency of the first demultiplexing signal Demux1 or the frequency of the second demultiplexing signal Demux2 is higher than a frequency of the second scan signal S2.

In one embodiment, the first demultiplexing signal Demux1 and the second demultiplexing signal Demux2 can work at the same time. This way, a charging time of the data signal DA in the first sub-pixel circuit 100 and the second sub-pixel circuit 200 can be extended, thus preventing insufficient charging of the corresponding sub-pixels.

In one embodiment, the second sub-pixel circuit 200 can comprise the second light-emitting unit 71, a second driving unit 11, a second light-emitting control unit 61, a second initialization unit 31, a second storage unit 51, a second compensation unit 21, and a second reset unit 41 which respectively correspond to and have the same functions as the light-emitting unit 70, the driving unit 10, the light-emitting control unit 60, the initialization unit 30, the storage unit 50, the compensation unit 20, and the reset unit 40.

The second sub-pixel circuit 200 can further comprise a second light-emitting device D1-2, a second driving transistor T1-2, a third light-emitting control transistor T5-2, a fourth light-emitting control transistor T6-2, a second initialization transistor T4-2, a second storage capacitor C1-2, a second compensation transistor T3-2, and a second reset transistor T7-2 which respectively correspond to a light-emitting device D1-1, a driving transistor T1-1, a first light-emitting control transistor T5-1, a second light-emitting control transistor T6-1, an initialization transistor T4-1, a storage capacitor C1-1, a compensation transistor T3-1, and a reset transistor T7-1.

In one embodiment, the present disclosure provides a display panel which comprises the pixel circuit in any of the above embodiments.

It should be noted that, the display panel of the present embodiment further comprises at least one demultiplexing circuit. The demultiplexing circuit is connected to the writing circuit and configured to provide the demultiplexing signal corresponding to the pixel circuit.

It should be noted that since the display panel of the present embodiment at least has the pixel circuit in any of the above embodiments, the display panel of the present embodiment at least has the corresponding functions or effects of the pixel circuit.

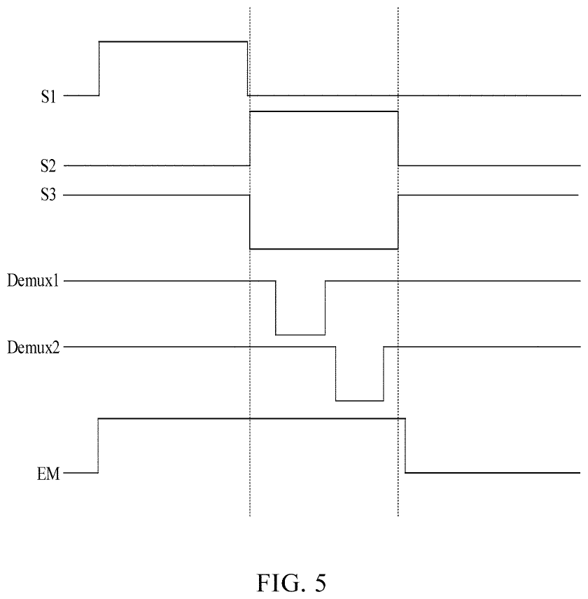

Referring to FIG. 5, it shows a timing diagram of key signals. These key signals include the first scan signal S1, the second scan signal S2, the third scan signal S3, the first demultiplexing signal Demux1, the second demultiplexing signal Demux2, and the light-emitting control signal EM.

Taking the first sub-pixel circuit 100 as an example, in a first stage, during a period when the light-emitting control signal EM is at a high level, the first light-emitting control transistor T5-1 and the second light-emitting control transistor T6-1 in the light-emitting control unit 60 are in an off state; the first scan signal S1 is at a high level, and the initial voltage signal Vint is transmitted to the gate of the driving transistor T1-1; then, the first scan signal S1 is changed to a low level, the second scan signal S2 and the third scan signal S3 are in an operation cycle, and the compensation transistor T3-1 and the reset transistor T7-1 are turned on. During this period, the first demultiplexing signal Demux1 and the second demultiplexing signal Demux2 are in an operation cycle sequentially, that is, the first demultiplexing signal Demux1 and the second demultiplexing signal Demux2 can, but are not limited to, work at different times, and the data signal DA is sequentially written into the corresponding sub-pixel circuits. In a second stage, when the light-emitting control signal EM is at a low level, the first light-emitting control transistor T5-1 and the second light-emitting control transistor T6-1 in the light-emitting control unit 60 are in an on state.

It should be noted that, when the first demultiplexing signal Demux1 and the second demultiplexing signal Demux2 work at different times, the frequency of the first demultiplexing signal Demux1 or the frequency of the second demultiplexing signal Demux2 is not less than two times that of the third scan signal.

It can be understood that those of ordinary skill in the art can make equivalent replacements or changes according to the technical solution and inventive concept of the present application, and all such changes or replacements should be deemed to fall within the protection scope defined by the appended claims of the present application.

What is claimed is:

1. A pixel circuit, comprising:
a first sub-pixel circuit;
a second sub-pixel circuit; and
a writing circuit connected to the first sub-pixel circuit and the second sub-pixel circuit, wherein the writing circuit is configured to control a data signal to be coupled to the first sub-pixel circuit based on a first demultiplexing signal, and control the data signal to be coupled to the second sub-pixel circuit according to a second demultiplexing signal.

2. The pixel circuit according to claim 1, wherein an input signal of the first sub-pixel circuit is the same as an input signal of the second sub-pixel circuit;
wherein the input signal comprises at least one of a first power signal, a second power signal, a light-emitting control signal, a scan signal, and an initial voltage signal.

3. The pixel circuit according to claim 1, wherein the writing circuit comprises:
a first thin-film transistor coupled to the first sub-pixel circuit and configured to control the data signal to be coupled to the first sub-pixel circuit according to the first demultiplexing signal; and
a second thin-film transistor coupled to the second sub-pixel circuit and configured to control the data signal to be coupled to the second sub-pixel circuit according to the second demultiplexing signal;
wherein the first demultiplexing signal is different from the second demultiplexing signal.

4. The pixel circuit according to claim 1, wherein the first sub-pixel circuit or the second sub-pixel circuit comprises:
a driving unit connected in series to a light-emitting circuit consisting of a first power signal and a second power signal and configured to control a current flowing through the light-emitting circuit; and
a compensation unit coupled to the driving unit and configured to adjust a potential of a control terminal of the driving unit to a potential of an output terminal of the driving unit according to a second scan signal, so as to reduce or eliminate a current leakage of the driving unit.

5. The pixel circuit according to claim 4, wherein the first sub-pixel circuit or the second sub-pixel circuit further comprises:
an initialization unit connected to the driving unit and configured to control an initial voltage signal to be coupled to the driving unit according to the first scan signal.

6. The pixel circuit according to claim 5, wherein the first sub-pixel circuit or the second sub-pixel circuit further comprises:
a storage unit coupled to the driving unit, the initialization unit, and the first power signal, wherein the storage unit is configured to adjust the potential of the control terminal of the driving unit.

7. The pixel circuit according to claim 6, wherein the first sub-pixel circuit or the second sub-pixel circuit further comprises:
a light-emitting unit connected in series to the light-emitting circuit; and
a light-emitting control unit connected in series to the light-emitting circuit and configured to on-off control the light-emitting unit to emit light according to a light-emitting control signal.

8. The pixel circuit according to claim 7, wherein the first sub-pixel circuit or the second sub-pixel circuit further comprises:
a reset unit connected to the initial voltage signal and an anode of the light-emitting unit and configured to control the initial voltage signal to be coupled to the anode of the light-emitting unit according to a third scan signal to reset a potential of the anode.

9. A pixel circuit, comprising:
a first sub-pixel circuit; and
a writing circuit connected to the first sub-pixel circuit and configured to control a data signal to be coupled to the first sub-pixel circuit according to a first demultiplexing signal.

10. The pixel circuit according to claim 9, wherein the first sub-pixel circuit comprises:
a driving transistor, wherein a source of the driving transistor is connected to an output terminal of the writing circuit; and
a compensation transistor, wherein an input terminal of the compensation transistor is connected to a gate of the driving transistor, an output terminal of the compensation transistor is connected to a drain of the driving transistor, and a control terminal of the compensation transistor is connected to a second scan signal and configured to adjust a potential difference between the gate and the drain of the driving transistor according to the second scan signal to reduce or eliminate a current leakage of the driving transistor.

11. The pixel circuit according to claim 10, wherein the driving transistor is a polysilicon thin-film transistor, and the compensation transistor is an oxide thin-film transistor.

12. The pixel circuit according to claim 11, wherein the first sub-pixel circuit further comprises an initialization transistor;
an input terminal of the initialization transistor is connected to an initial voltage signal, a control terminal of the initialization transistor is connected to a first scan signal, and an output terminal of the initialization transistor is connected to the gate of the driving transistor.

13. The pixel circuit according to claim 12, wherein the first sub-pixel circuit further comprises a storage capacitor;
a first end of the storage capacitor is connected to a first power signal, and a second end of the storage capacitor is connected to the gate of the driving transistor.

14. The pixel circuit according to claim 13, wherein the first sub-pixel circuit further comprises a first light-emitting control transistor, a second light-emitting control transistor, and a light-emitting device;
an input terminal of the first light-emitting control transistor is connected to the first power signal, and an output terminal of the first light-emitting control transistor is connected to the source of the driving transistor;
an input terminal of the second light-emitting control transistor is connected to the drain of the driving transistor, and the light-emitting control signal is connected to a control terminal of the first light-emitting control transistor and a control terminal of the second light-emitting control transistor; and
an anode of the light-emitting device is connected to an output terminal of the second light-emitting control transistor, and a cathode of the light-emitting device is connected to a second power signal.

15. The pixel circuit according to claim 14, wherein the first sub-pixel circuit further comprises a reset transistor;
an input terminal of the reset transistor is connected to the initial voltage signal; a control terminal of the reset transistor is connected to a third scan signal; and an output terminal of the reset transistor is connected to the output terminal of the second light-emitting control transistor.

16. The pixel circuit according to claim 12, wherein the initialization transistor is an oxide thin-film transistor.

17. A driving method of a pixel circuit, wherein the pixel circuit is provided with a first sub-pixel circuit, a second sub-pixel circuit, and a writing circuit, and the driving method comprises:
providing a first demultiplexing signal, a second demultiplexing signal, a data signal, and a corresponding input signal, wherein the input signal comprises at least one of a first power signal, a second power signal, a light-emitting control signal, a first scan signal, a second scan signal, a third scan signal, and an initial voltage signal;
the writing circuit controlling the data signal to be coupled to the first sub-pixel circuit according to the first demultiplexing signal;
the writing circuit controlling the data signal to be coupled to the second sub-pixel circuit according to the second demultiplexing signal;
the first sub-pixel circuit driving a first light-emitting unit according to the input signal to perform a first display operation; and
the second sub-pixel circuit driving a second light-emitting unit according to the input signal to perform a second display operation;
wherein a frequency of the third scan signal is less than or equal to a sum of frequencies of the first demultiplexing signal and the second demultiplexing signal.

18. The driving method according to claim 17, wherein the writing circuit comprises a first writing circuit and a second writing circuit;
the first writing circuit controls the data signal to be coupled to the first sub-pixel circuit according to the first demultiplexing signal; and
the second writing circuit controls the data signal to be coupled to the second sub-pixel circuit according to the second demultiplexing signal.

19. The driving method according to claim 18, wherein a frequency of the first demultiplexing signal is the same as a frequency of the second demultiplexing signal.

20. The driving method according to claim 17, wherein the first demultiplexing signal and the second demultiplexing signal work at different times.
